(19) United States
(12) Patent Application Publication
(10) Pub. No.: US 2007/0157992 A1
(43) Pub. Date: Jul. 12, 2007

(54) AC servo motor veneer lathe drive system

(75) Inventor: John Oldham, Delta (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Arrow Speed Controls Limited, Vancouver (CA)

(21) Appl. No.: 11/304,607

(22) Filed: Dec. 16, 2005

(51) Int. Cl. B27L 5/02

(52) U.S. Cl. 144/209.1

(57) ABSTRACT

Multiple AC servo motors having low weight moment of inertia (Wk²) characteristics are drivingly inter-connected to form a veneer lathe drive system. Two, three or four motors can be drivingly coupled to one another and to drive spindles located on either or both sides of the lathe.

### TECHNICAL FIELD

Multiple AC servo motors having relatively low inertia and relatively high output horsepower capability are configured to quickly accelerate a veneer peeling lathe from zero rpm to the peeling speed, and to quickly decelerate the lathe after peeling a block.

### BACKGROUND

FIG. 1 schematically depicts a veneer peeling lathe 10 having drive spindles 12. Lathe 10 is driven by a prior art AC (or DC) motor 14 via timing belt 16 which is coupled between motor 14's drive shaft 18 and one of spindles 12 (for simplification, the gear box typically used to couple motor 14 to one of spindles 12 is not shown). In operation, a lathe charger (not shown) is controllably actuated to load a peeling block (not shown) into lathe 10. Motor 14 is then controllably actuated to drive lathe 10, accelerating spindles 12 and the block from a rotational speed of zero revolutions per minute (rpm) to a peeling speed of about 2,000 rpm. Motor 14 continues to drive lathe 10 at the peeling speed while lathe 10's veneer peeling knife (not shown) is controllably advanced into the block to peel an ideally continuous strip or ribbon of veneer from the block. As soon as the block has been peeled down to a predefined core diameter, motor 14 is actuated to decelerate spindle 12 and the block's core to zero rpm. The core is then ejected from lathe 10 and the peeling process is repeated by actuating the charger to load a fresh block into lathe 10.

In order to sustain high volume, low cost veneer production, each fresh block must be accelerated from zero rpm to the peeling speed as quickly as possible; and, after the block has been peeled, the core must be decelerated to zero rpm as quickly as possible. Prior art AC or DC motor driven lathe systems are able to peel about 12-15 blocks per minute, producing veneer ribbon at a rate of about 1,200 lineal feet per minute. It is thus apparent that such prior art systems require 4-5 seconds per block to accelerate from zero to 2,000 rpm, peel the block, then decelerate from 2,000 to zero rpm. A significant portion of the 4-5 seconds-per-block time interval is consumed in accelerating spindles 12 and the block from zero rpm to the peeling speed, and in decelerating spindles 12 and the core from the peeling speed to zero rpm. These acceleration and deceleration times are preferably minimized. The need for faster acceleration/deceleration times is exacerbated by the fact that currently available peeling logs (from which blocks are produced) tend to have smaller diameters than the peeling logs which were abundant in the relatively recent past. More smaller diameter blocks must be peeled within a given time interval to produce the same quantity of veneer that would have been produced by peeling larger diameter blocks. Since a significant portion of the time required to peel each block is consumed in accelerating/decelerating the block/core as aforesaid, it is apparent that faster lathe acceleration/deceleration times are necessary if the same quantity of veneer is to be produced by peeling smaller diameter blocks.

The time required to accelerate or decelerate a motor-driven load is proportional to the motor's weight moment of inertia which is conventionally expressed as Wk², where W represents the motor's weight in kilograms (kg) and k represents the radius of gyration in metres (m). A motor's Wk² characteristic must be reduced in order to reduce the time required by the motor to accelerate or decelerate a load. Since the radius of gyration (i.e. the radius of the block) is fixed, it is apparent that the motor's weight W must be reduced in order to reduce the time required by the motor to accelerate or decelerate a load. However, the motor's weight W cannot be reduced in isolation—other factors such as the motor's output horsepower (HP) must be taken into account. The substantial horsepower required to operate a veneer peeling lathe has prevented significant reduction of the Wk² characteristic of prior art veneer lathe drive motors, thereby preventing significant reduction of the time required by such motors to accelerate or decelerate a load and thus limiting the number of blocks that can be peeled within a particular time interval.

A veneer peeling lathe requires a motor having substantial output horsepower capability—for example 750 HP or greater. Prior art motors capable of producing the required horsepower have substantial weight, and consequently have relatively high Wk² characteristics. To achieve faster acceleration/deceleration, the horsepower output capability of the lathe's drive motor must be increased. For example, a 750 HP motor might have to be replaced with a 1,500 HP motor. However, such doubling of the horsepower output capability of a conventional AC or DC motor requires a substantial increase in motor size, and a corresponding increase in the motor's Wk² characteristic, thereby unavoidably increasing the time required to accelerate or decelerate the motor. This limitation is overcome as described below.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. The embodiments and figures disclosed herein are to be considered as illustrative rather than restrictive.

FIG. 1 schematically depicts a veneer peeling lathe driven by a prior art AC (or DC) motor.

FIG. 2 schematically depicts a first embodiment of a veneer peeling lathe driven by four AC servo motors.

FIG. 3 schematically depicts a second embodiment of a veneer peeling lathe driven by four AC servo motors.

FIG. 4 schematically depicts a third embodiment of a veneer peeling lathe driven by four AC servo motors.

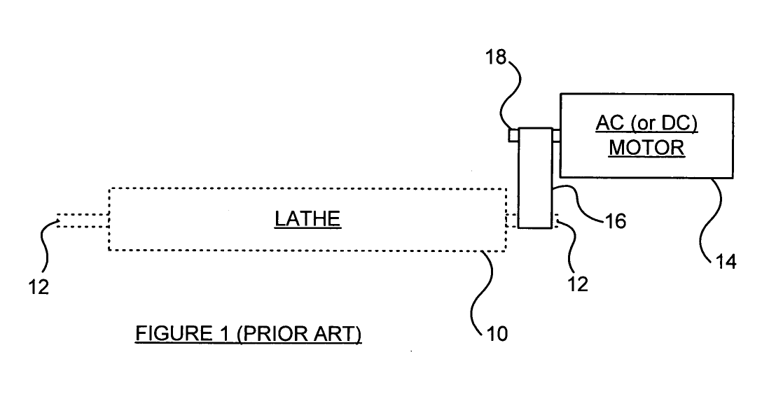

FIGS. 1-4 are not drawn to scale—the motors are schematically depicted on a scale which is exaggerated relative the scale of the schematically depicted lathe.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

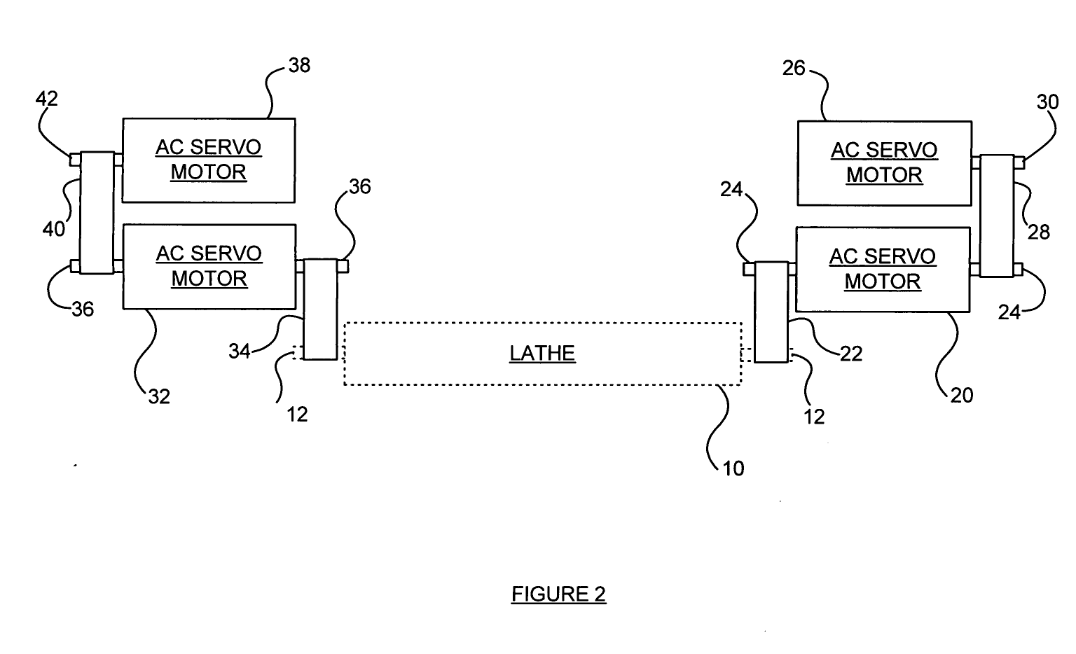

FIG. 2 depicts a first embodiment in which veneer peeling lathe 10 is driven by four AC servo motors 20, 26, 32, 38, two of which are mounted on each side of lathe 10 (for simplification, the gear boxes typically used to couple the motors to the lathe are not shown). AC servo motor 20 is drivingly coupled to one side of lathe 10 by timing belt 22 which is coupled between AC servo motor 20's drive shaft 24 and lathe 10's spindle 12. AC servo motor 26 is drivingly coupled to AC servo motor 20 by timing belt 28 which is coupled between drive shafts 24, 30 of AC servo motors 20, 26. AC servo motor 32 is drivingly coupled to the opposite side of lathe 10 by timing belt 34 which is coupled between AC servo motor 32's drive shaft 36 and lathe 10's spindle 12. AC servo motor 38 is drivingly coupled to AC servo motor 32 by timing belt 40 which is coupled between drive shafts 36, 42 of AC servo motors 32, 38.

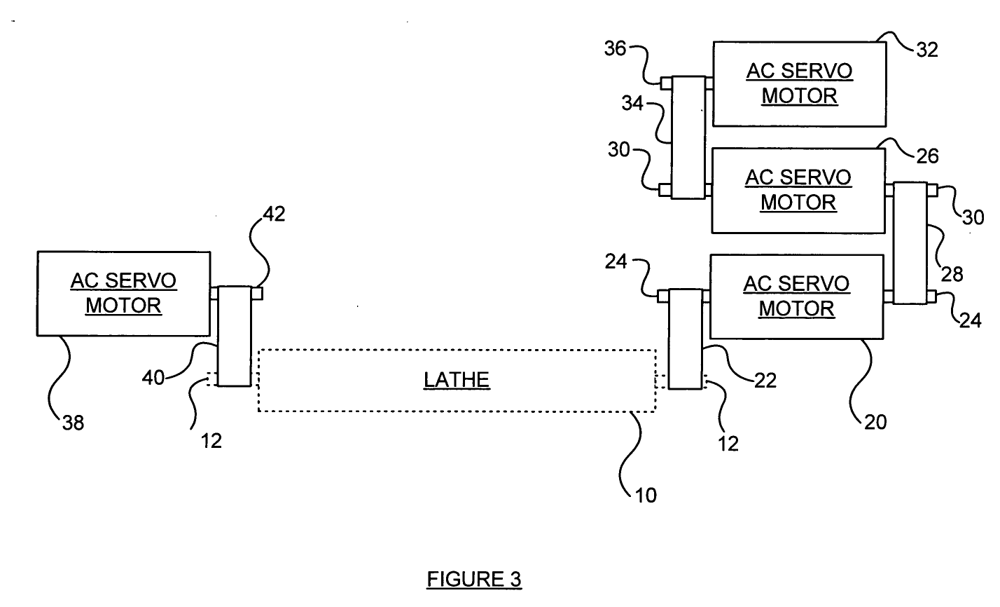

FIG. 3 depicts a second embodiment in which veneer peeling lathe 10 is driven by four AC servo motors 20, 26, 32, 38, three of which (motors 20, 26, 32) are mounted on one side of lathe 10, with the fourth (motor 38) being mounted on the opposite side of lathe 10 (for simplification, the gear boxes typically used to couple the motors to the lathe are not shown). AC servo motor 20 is drivingly coupled to one side of lathe 10 by timing belt 22 which is coupled between AC servo motor 20's drive shaft 24 and lathe 10's spindle 12. AC servo motor 26 is drivingly coupled to AC servo motor 20 by timing belt 28 which is coupled between drive shafts 24, 30 of AC servo motors 20, 26. AC servo motor 32 is drivingly coupled to AC servo motor 26 by timing belt 34 which is coupled between drive shafts 30, 36 of AC servo motors 26, 32. AC servo motor 38 is drivingly coupled to the opposite side of lathe 10 by timing belt 40 which is coupled between AC servo motor 38's drive shaft 42 and lathe 10's spindle 12.

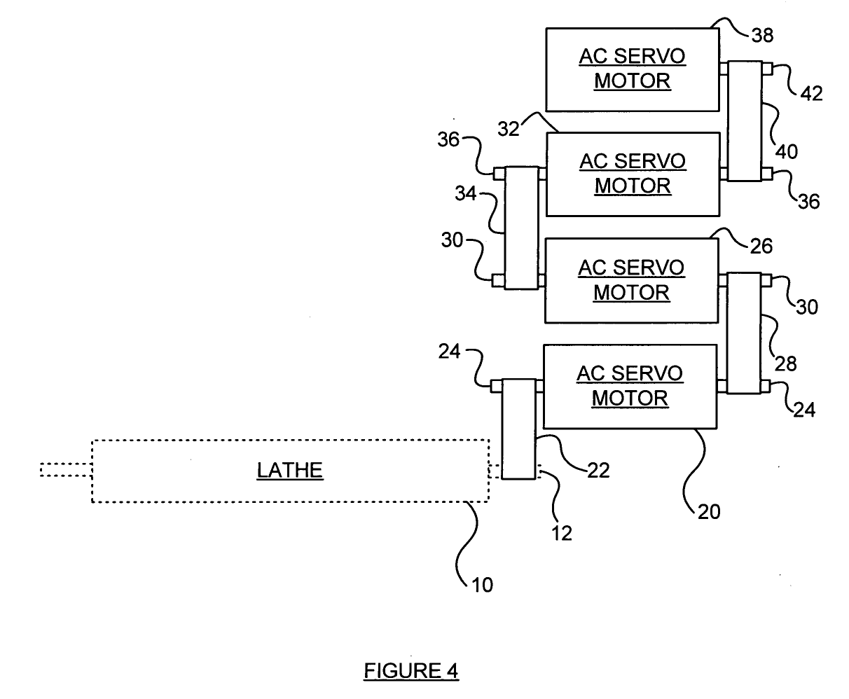

FIG. 4 depicts a third embodiment in which veneer peeling lathe 10 is driven by four AC servo motors 20, 26, 32, 38 all of which are mounted on the same side of lathe 10 (for simplification, the gear boxes typically used to couple the motors to the lathe are not shown). AC servo motor 20 is drivingly coupled to one side of lathe 10 by timing belt 22 which is coupled between AC servo motor 20's drive shaft 24 and lathe 10's spindle 12. AC servo motor 26 is drivingly coupled to AC servo motor 20 by timing belt 28 which is coupled between drive shafts 24, 30 of AC servo motors 20, 26. AC servo motor 32 is drivingly coupled to AC servo motor 26 by timing belt 34 which is coupled between drive shafts 30, 36 of AC servo motors 26, 32. AC servo motor 38 is drivingly coupled to AC servo motor 32 by timing belt 40 which is coupled between drive shafts 36, 42 of AC servo motors 32, 38.

In any of the first, second or third embodiments, each one of motors 20, 26, 32, 38 may be a MELSERVO™ J2 Super Series AC servo motor (type HA-JFS 110K24), available from Mitsubishi Electric Corporation, Tokyo, Japan. Such motors have a pre-amplification output horsepower capability of about 150 HP. When coupled to a compatible servo amplifier (e.g. MELSERVO™ J2 Super Series AC servo amplifier, type MR-J2S-110 KA4 or MR-J2S-110 KB4, also available from Mitsubishi Electric Corporation, Tokyo, Japan) the motor's output horsepower capability is increased by 250%, enabling the motor to deliver 375 HP. Four such motors can thus deliver a combined total of 1,500 HP when combined in accordance with any of the first, second or third embodiments.

A key advantage of the MELSERVO™ J2 Super Series AC servo motor is its low weight moment of inertia (Wk²) characteristic, which is considerably lower than that of a comparable prior art AC or DC (non-servo) motor. For example, a MELSERVO™ J2 Super Series AC servo motor having a 375 HP capability weighs about 460 kg and has a Wk² of about 0.53 kg·m². By contrast, a prior art veneer peeling lathe drive system typically utilizes a single, large AC or DC (non-servo) motor, for example a 750 HP AC motor having a Wk² characteristic approximately twenty times greater than that of a single MELSERVO™ J2 Super Series AC servo motor having a 375 HP capability as aforesaid, and approximately five times greater than that of four MELSERVO™ J2 Super Series AC servo motors having a 1,500 HP capability when combined in accordance with any of the first, second or third embodiments.

The low Wk² characteristic of motors 20, 26, 32, 38, when combined in accordance with any of the first, second or third embodiments, reduces the time required by the combined motors to accelerate or decelerate lathe 10's spindles 12 and a block or core engaged by spindles 12. For example, motors 20, 26, 32, 38 are able to accelerate spindles 12 and a block from zero rpm to a peeling speed of about 2,000 rpm within about 0.7 seconds, and decelerate spindles 12 and the peeled block's core from about 2,000 to zero rpm within about 0.3 seconds. Consequently, when combined in accordance with any of the first, second or third embodiments, motors 20, 26, 32, 38 are capable of driving lathe 10 to peel about 20 blocks per minute, producing veneer ribbon at a rate of about 1,650 lineal feet per minute. By contrast, a prior art veneer peeling lathe drive system utilizing a single 750 HP AC motor is typically able to peel about 12-15 blocks per minute, producing veneer ribbon at a rate of about 1,200 lineal feet per minute. It can thus be seen that the first, second or third embodiments provide roughly a 30% improvement over such a prior art system, which is a very significant advantage.

It is counterintuitive to use multiple AC servo motors to drive a veneer peeling lathe. Conventional veneer peeling lathe drive systems use a single, large, AC or DC (non-servo) motor. Multiple motors are not normally used in veneer peeling lathe drive systems, perhaps because a multiple motor drive system is more complex and is usually more expensive than a single motor drive system. Moreover, servo motors are commonly perceived as relatively small devices best suited to use in precision positioning applications and as being relatively unsuited to use in applications requiring substantial drive horsepower such as veneer peeling lathe drive applications. It has nevertheless been discovered that AC servo motors such as the aforementioned MELSERVO™ J2 Super Series motor can be used in veneer peeling lathe drive applications, due to their relatively low Wk² characteristic and relatively high output horsepower capability.

A further advantage of the aforementioned MELSERVO™ J2 Super Series AC servo motor is its high resolution, 17-bit position encoder, which produces 131,072 pulses per revolution (ppr) of the motor's drive shaft. By contrast, a conventional servo motor shaft encoder may produce 1,024 ppr of the motor's drive shaft. The MELSERVO™ J2 Super Series motor's higher precision encoder facilitates much more accurate determination of the rotational position and speed of the motor's drive shaft than is attainable with a lower precision 1,024 ppr prior art encoder. Such higher precision also facilitates faster detection of attainment of a desired peeling speed and faster detection of cessation of rotation of the motor's drive shaft, which in turn reduces the time required by combined motors 20, 26, 32, 38 to accelerate or decelerate lathe 10's spindles 12 and a block or core engaged by spindles 12. Such higher precision additionally facilitates more accurate control of the thickness of the veneer ribbon produced as the block is peeled by lathe 10. For example, a lathe driven by AC servo motors 20, 26, 32, 38 may produce a veneer ribbon having a thickness tolerance 0.001 inches smaller than that of the veneer ribbon produced by driving the same lathe with a prior art lathe drive system. Although seemingly insignificant, the resultant savings in wood fibre, when extrapolated over one year, implies a cost saving on the order of one million Canadian dollars, thus revealing another very significant advantage of the first, second or third embodiments.

Yet another advantage of the first, second or third embodiments is the redundancy inherent in the provision of multiple drive motors. For example, if any one of motors 20, 26, 32 or 38 fails, then the other three, non-failed, motors will continue to deliver approximately 95% of the drive capability of the four motor system, enabling virtually uninterrupted production of veneer. Veneer production could even continue, albeit on a reduced scale, if any two of motors 20, 26, 32 or 38 failed. If a failed motor is able to rotate it can be allowed to freewheel until it can be conveniently removed and replaced. If a failed motor is unable to rotate, its timing belt can be disconnected to isolate it until it can be conveniently removed and replaced.

A still further advantage of the first, second or third embodiments is the inherent load sharing capability of an interconnected arrangement of multiple AC motors. Without load sharing, one or more of motors 20, 26, 32, 38 would impose an undesirable drag force on the other motors, thereby increasing the time required to accelerate or decelerate the motors and the load driven by the motors. AC motors (including AC servo motors) have an inherent load sharing capability, due to their slip characteristics. Briefly, “slip” is the difference between the rotational speed of a rotating (synchronous) magnetic field and the rotational speed of the motor's rotor. Slip generally increases with torque. If two or more AC motors are coupled to a variable frequency drive, then those motors will automatically load share amongst themselves.

Load sharing amongst two or more DC motors can be achieved by connecting the DC motors in a master-slave arrangement. In one common master-slave arrangement, one or more slave DC motors attempt to follow (i.e. match) a master DC motor's rotational speed. This is difficult to achieve, due to mechanical factors such as differences between supposedly identical DC motors, the motors' mechanical couplings, the mechanical loads to which the motors are coupled, etc. In another common master-slave arrangement, one or more DC slave motors attempt to follow (i.e. match) a master DC motor's output torque, without regard to the rotational speed of any particular motor. The first, second or third embodiments avoid the complexities and limitations of DC motor load sharing requirements.

As previously mentioned, the redundancy inherent in the provision of multiple drive motors facilitates continued veneer production, on a somewhat reduced scale, if any two of motors 20, 26, 32, 38 fail. In theory, in order to reduce mechanical complexity, two larger AC servo motors could be used instead of the four AC servo motors 20, 26, 32, 38. However, larger AC servo motors having adequate pre-amplification output horsepower capability (e.g. 300 HP) are not presently available. Even if a 300 HP AC servo motor becomes available, in the absence of presently unforseen advances in AC servo motor technology, the Wk² characteristic of a hypothetical 300 HP AC servo motor may be too high to facilitate reduction of the time required to accelerate or decelerate a load on a par with the reduction facilitated by the aforementioned first, second or third embodiments utilizing four MELSERVO™ J2 Super Series AC servo motors 20, 26, 32, 38. Consequently, two 300 HP AC servo motors may have a higher overall Wk² characteristic than four 150 HP MELSERVO™ J2 Super Series AC servo motors, and may therefore be unable to attain acceleration/deceleration performance comparable to that of four 150 HP MELSERVO™ J2 Super Series AC servo motors.

While a number of exemplary aspects and embodiments have been discussed above, those of skill in the art will recognize certain modifications, permutations, additions and sub-combinations thereof. For example, although AC servo motors are preferred, substantial, albeit reduced, benefits can be attained by substituting non-servo AC motors for AC servo motors 20, 26, 32, 38. Although multiple DC motors could, in theory, be substituted for AC servo motors 20, 26, 32, 38 this is unlikely to be practical in most situations-even if a suitable load sharing arrangement could be implemented-since multiple DC motors would present commutator and brush maintenance difficulties. It is therefore intended that the following appended claims and claims hereafter introduced are interpreted to include all such modifications, permutations, additions and sub-combinations as are within their true spirit and scope.

What is claimed is:

1. A veneer lathe drive system, comprising:
(a) a first AC motor having a first drive shaft drivingly coupled to a first drive spindle on a first side of the lathe; and
(b) a second AC motor having a second drive shaft drivingly coupled to the first drive shaft.

2. A veneer lathe drive system as defined in claim 1, further comprising a third AC motor having a third drive shaft drivingly coupled to the second drive shaft.

3. A veneer lathe drive system as defined in claim 2, further comprising a fourth AC motor having a fourth drive shaft drivingly coupled to the third drive shaft.

4. A veneer lathe drive system as defined in claim 1, further comprising a third AC motor having a third drive shaft drivingly coupled to a second drive spindle on a second side of the lathe.

5. A veneer lathe drive system as defined in claim 4, further comprising a fourth AC motor having a fourth drive shaft drivingly coupled to the third drive shaft.

6. A veneer lathe drive system as defined in claim 2, further comprising a fourth AC motor having a fourth drive shaft drivingly coupled to a second drive spindle on a second side of the lathe.

7. A veneer lathe drive system, comprising:
(a) a first AC servo motor having a first drive shaft drivingly coupled to a first drive spindle on a first side of the lathe; and
(b) a second AC servo motor having a second drive shaft drivingly coupled to the first drive shaft.

8. A veneer lathe drive system as defined in claim 7, further comprising a third AC servo motor having a third drive shaft drivingly coupled to the second drive shaft.

9. A veneer lathe drive system as defined in claim 8, further comprising a fourth AC servo motor having a fourth drive shaft drivingly coupled to the third drive shaft.

10. A veneer lathe drive system as defined in claim 7, further comprising a third AC servo motor having a third drive shaft drivingly coupled to a second drive spindle on a second side of the lathe.

11. A veneer lathe drive system as defined in claim 10, further comprising a fourth AC servo motor having a fourth drive shaft drivingly coupled to the third drive shaft.

12. A veneer lathe drive system as defined in claim 8, further comprising a fourth AC servo motor having a fourth drive shaft drivingly coupled to a second drive spindle on a second side of the lathe.

13. A veneer lathe drive system as defined in claim 7, wherein the first AC servo motor and the second AC servo motor each have a pre-amplification power output capability of about 150 HP, a weight of about 460 kg and a weight moment of inertia of about 0.53 kg·m².

14. A veneer lathe drive system as defined in claim 8, wherein the third AC servo motor has a pre-amplification power output capability of about 150 HP, a weight of about 460 kg and a weight moment of inertia of about 0.53 kg·m².

15. A veneer lathe drive system as defined in claim 9, wherein the fourth AC servo motor has a pre-amplification power output capability of about 150 HP, a weight of about 460 kg and a weight moment of inertia of about 0.53 kg·m².

16. A veneer lathe drive system as defined in claim 10, wherein the third AC servo motor has a pre-amplification power output capability of about 150 HP, a weight of about 460 kg and a weight moment of inertia of about 0.53 kg·m².

17. A veneer lathe drive system as defined in claim 11, wherein the fourth AC servo motor has a pre-amplification power output capability of about 150 HP, a weight of about 460 kg and a weight moment of inertia of about 0.53 kg·m².

18. A veneer lathe drive system as defined in claim 12, wherein the fourth AC servo motor has a pre-amplification power output capability of about 150 HP, a weight of about 460 kg and a weight moment of inertia of about 0.53 kg·m².

19. A veneer lathe drive method, comprising:
(a) drivingly coupling a first drive shaft of a first AC motor to a first drive spindle on a first side of the lathe;
(b) drivingly coupling a second drive shaft of a second AC motor to the first drive shaft; and
(c) energizing the first AC motor and the second AC motor to drivingly rotate the first drive spindle.

20. A veneer lathe drive method as defined in claim 19, further comprising drivingly coupling a third drive shaft of a third AC motor to the second drive shaft, and energizing the third AC motor to further drivingly rotate the first drive spindle.

21. A veneer lathe drive method as defined in claim 20, further comprising drivingly coupling a fourth drive shaft of a fourth AC motor to the third drive shaft, and energizing the fourth AC motor to further drivingly rotate the first drive spindle.

22. A veneer lathe drive method as defined in claim 19, further comprising drivingly coupling a third drive shaft of a third AC motor to a second drive spindle on a second side of the lathe, and energizing the third AC motor to drivingly rotate the second drive spindle.

23. A veneer lathe drive method as defined in claim 22, further comprising drivingly coupling a fourth drive shaft of a fourth AC motor to the third drive shaft, and energizing the fourth AC motor to further drivingly rotate the second drive spindle.

24. A veneer lathe drive method as defined in claim 20, further comprising drivingly coupling a fourth drive shaft of a fourth AC motor to a second drive spindle on a second side of the lathe, and energizing the fourth AC motor to drivingly rotate the second drive spindle.

25. A veneer lathe drive method, comprising:
(a) drivingly coupling a first drive shaft of a first AC servo motor to a first drive spindle on a first side of the lathe;
(b) drivingly coupling a second drive shaft of a second AC servo motor to the first drive shaft; and
(c) energizing the first AC servo motor and the second AC servo motor to drivingly rotate the first drive spindle.

26. A veneer lathe drive method as defined in claim 25, further comprising drivingly coupling a third drive shaft of a third AC servo motor to the second drive shaft, and energizing the third AC servo motor to further drivingly rotate the first drive spindle.

27. A veneer lathe drive method as defined in claim 26, further comprising drivingly coupling a fourth drive shaft of a fourth AC servo motor to the third drive shaft, and energizing the fourth AC servo motor to further drivingly rotate the first drive spindle.

28. A veneer lathe drive method as defined in claim 25, further comprising drivingly coupling a third drive shaft of a third AC servo motor to a second drive spindle on a second side of the lathe, and energizing the third AC servo motor to drivingly rotate the second drive spindle.

29. A veneer lathe drive method as defined in claim 28, further comprising drivingly coupling a fourth drive shaft of a fourth AC servo motor to the third drive shaft, and energizing the fourth AC servo motor to further drivingly rotate the second drive spindle.

30. A veneer lathe drive method as defined in claim 26, further comprising drivingly coupling a fourth drive shaft of a fourth AC servo motor to a second drive spindle on a second side of the lathe, and energizing the fourth AC servo motor to drivingly rotate the second drive spindle.
